(19) United States
(12) Patent Application Publication
(10) Pub. No.: US 2025/0274721 A1
(43) Pub. Date: Aug. 28, 2025

(54) INTERNET PROTOCOL ADDRESS MATCHING

(71) Applicant: MOTIONWORKS AI INC., ATLANTA,, GA (US)

(72) Inventors: Kimberly Frank, Mount Tabor, NJ (US); Matthew Martimo, Signal Mountain, TN (US); Ryan Kinskey, Alpharetta, GA (US)

(21) Appl. No.: 18/589,128

(22) Filed: Feb. 27, 2024

(51) Int. Cl. H04W 4/029; H04L 67/50

(52) U.S. Cl. CPC H04W 4/029; H04L 67/535

(57) ABSTRACT

A cross-device IP address matching system is disclosed that receives a public IP address associated with a particular transmission of digital content and furthermore determines computing devices associated with the public IP address. The system receives data from one or more applications downloaded onto the computing devices, where the data is processed to identify behavioral characteristics corresponding to the computing devices and their corresponding users. The system generates longitudinal profiles for the computing devices based on the received data and the identified behavioral characteristics. The data received from one or more applications includes public IP addresses through which the respective computing devices and applications routed internet communications. In response to receiving a pubic IP address associated with a particular transmission of digital content, the system compares the public IP address to IP addresses stored in connection with the device profiles.

### TECHNICAL FIELD

The present systems and processes relate generally to internet protocol (IP) address matching, and more specifically to matching IP addresses with geographical location data and specific establishments.

### BACKGROUND

Public IP addresses typically include information indicative of a general geographical region around where the IP address and devices using the IP address are located. In particular, the Internet Service Providers (ISP's) that provide and assign public IP addresses for internet connectivity typically indicate, within the public IP addresses, the city, state, zip code, etc., of the entities to which public IP addresses are assigned; however, a device's location cannot be precisely located based solely on its public IP address. Therefore, there is a long-felt but unresolved need for cross-device IP address matching.

### BRIEF SUMMARY OF THE DISCLOSURE

Briefly described, and according to one embodiment, aspects of the present disclosure generally relate to IP address matching. More specifically, embodiments of the present disclosure relate to determining the location of a network device with a specific IP address based on an identified separate device associated with the same IP address and the separate device's historical location data.

In at least one embodiment, the present disclosure discusses a system operatively configured to receive one or more IP addresses. For example, the system can receive an IP address associated with a particular stream of digital content, or a similar type of transmitted data. The system can receive the IP address from a variety of sources, such as digital content streaming platforms (e.g., Netflix®, Hulu®, Amazon®, etc.), device manufacturers (e.g., Samsung®, Roku®, Motorola®, etc.), broadcast television providers (NBC®, Fox®, etc.), or any other appropriate entity. For example, in one embodiment the system is operatively configured to receive from a device manufacturer, such as Roku®, a list of IP addresses corresponding to one or more Roku®-manufactured devices (such as television sets or network appliance devices that enable content streaming) that are known to have requested and/or received a particular stream of content (e.g., a sports broadcast, a television series, etc.). In at least one example, in response to an individual using his/her Roku® device to select a particular show for viewing can cause the individual's public IP address (with which the Roku® device requests and receives digital content) to be recorded in connection with a recipient device (the Roku® device) that received the particular show.

In response to receiving an IP address, the system can determine if one or more devices (from which the system has previously received and stored data) are associated with the IP address. A device can be associated with an IP address in a variety of ways, such as establishing an internet connection via the IP address. For example, an employee at a restaurant may connect his/her mobile device to the restaurant's Wi-Fi® network and furthermore continue to use applications on his/her mobile device throughout the day. Continuing with the restaurant employee example, the employee might use a social media application to view and/or post content, or the employee might check his/her emails. Towards the end of the employee's shift, the employee might use a mapping and transit application on the device (such as Google® Maps® or Waze®) to estimate his/her home commute time, or the employee might place an order to be picked-up during his/her commute. Each of these activities performed on the employee's device, if the device is connected to the internet via the restaurant's Wi-Fi® network, are enabled using the restaurant's public IP address and establishes a digital “paper trail” that can be collected, tracked, and monitored. The system discussed herein can collect, record, and generally observe these digital “paper trails” for a plurality of devices to perform the disclosed cross-device IP matching processes.

In at least one embodiment, the systems and processes disclosed herein are operatively configured to generate profiles for devices, such as the employee's device from the example discussed above. The device profiles can include various types of data, and more specifically the device profiles include data corresponding to actions performed at, on, or with the devices. Given electronic computing devices are typically assigned type of device ID), these device ID's are often shared by the device with a network host when requesting to join a Wi-Fi® network, and the device ID's may be also be included in information transmitted over the internet. Accordingly, in response to receiving a particular device ID, the system can identify the particular device ID within various data sources and data sets, and the system can furthermore develop a profile based on digital behavior corresponding to that device ID.

Moreover, and referring back to the restaurant employee example, the system can receive a first batch of data (such as de-identified user data) from the service or platform the employee used to place his/her order for pick-up, and the de-identified data can include information such as device ID's, order details, order timestamps, device location data (such as GPS data), IP addresses from which orders were placed, etc. In various embodiments, the system can receive a second batch of de-identified data from a separate service or platform, such as the mapping and transit application that the employee used to estimate his/her commute time, and the system can cross-reference the first and second batches of de-identified data to determine commonalities between the data. For example, by cross-referencing the first and second batches of de-identified data, and furthermore by receiving subsequent data batches, the system can determine that a device with a particular device ID connects to the internet via a particular public IP address at or around a particular time and always at or around a particular geographical location.

In response to generating profiles for devices, the system can furthermore determine a location of an “unknown” network device (also referred to herein as a recipient device) by receiving a public IP address associated with the device. In at least one example, the “unknown” network devices, or recipient devices, are devices for which the system has no data on record, but the system receives public IP addresses in connection with the devices indicating that the devices were recipients of particular content. For example, consider that the restaurant at which the employee works has a television which is an “unknown” device given the system currently has no data from the television on record, and the restaurant displays a sporting event on the television for its patrons. The system can receive (from the cable broadcasting service, or another entity) the public IP address associated with receiving the sporting event broadcast transmission, and furthermore compare the public IP address to the stored device profiles to determine if the device profiles include a record of the public IP address. In response to determining that a device profile, such as the employee's device profile, includes a record of using the public IP address for internet connectivity, the system can more granularly process the data within the device profile, namely the device activities performed while connected to the internet via the IP address. By processing data such as the device location data included within the restaurant employee's device profile, and given the data is associated with the same IP address associated with receiving the sporting event broadcast transmission, the system can determine that the “unknown” network device's location is the same as the restaurant employee's device at the time of the sporting event broadcast. Moreover, the system can compare the geographical coordinates corresponding to the employee's location data to map data, or the like. By comparing the coordinates to map data, the system can determine a particular establishment at which the television is located.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram illustrating an example operational environment, according to one aspect of the present disclosure;

FIG. 2 is a diagram illustrating an example operational architecture, according to one aspect of the present disclosure;

FIG. 3 is a diagram illustrating an example system architecture, according to one aspect of the present disclosure;

FIG. 4 is a flowchart illustrating an example cross-device IP address matching process, according to one aspect of the present disclosure;

FIG. 5 is a flowchart illustrating an example IP conflict resolution process, according to one aspect of the present disclosure; and

FIG. 6 is a flowchart illustrating an example data ingestion process, according to one aspect of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to cross-device IP address matching. More specifically, embodiments of the present disclosure relate to determining the location of a network device with a specific IP address based on an identified separate device associated with the same IP address and the separate device's historical data, namely the separate device's location data and time data within the historical data.

In at least one embodiment, the present disclosure discusses a system operatively configured to receive one or more IP addresses. For example, the system can receive an IP address associated with a particular stream of digital content, or a similar type of transmitted data. The system can receive the IP address from a variety of sources, such as digital content streaming platforms (e.g., Netflix®, Hulu®, Amazon®, etc.), device manufacturers (e.g., Samsung®, Roku®, Motorola®, etc.), broadcast television providers (NBC®, Fox®, etc.), or any other appropriate entity. For example, in one embodiment the system is operatively configured to receive from a device manufacturer, such as Roku®, a list of IP addresses corresponding to one or more Roku®-manufactured devices (such as television sets or network appliance devices that enable content streaming) that are known to have requested and/or received a particular stream of content (e.g., a sports broadcast, a television series, etc.). In at least one example, in response to an individual using his/her Roku® device to select a particular show for viewing can cause the individual's public IP address (with which the Roku® device requests and receives digital content) to be recorded in connection with a device that received the particular show.

In response to receiving an IP address, the system determines if one or more devices (from which the system has previously received and stored data) are associated with the IP address. A device can be associated with an IP address in a variety of ways, such as establishing an internet connection via the IP address. For example, an employee at a restaurant may connect his/her mobile device to the restaurant's Wi-Fi® network and furthermore continue to use applications on his/her mobile device throughout the day. Continuing with the restaurant employee example, the employee might use a social media application to view and/or post content, or the employee might check his/her emails. Towards the end of the employee's shift, the employee might use a mapping and transit application on the device (such as Google® Maps® or Waze®) to estimate his/her home commute time, or the employee might place an order to be picked-up during his/her commute. Each of these activities performed on the employee's device, if the device is connected to the internet via the restaurant's Wi-Fi® network, are enabled using the restaurant's public IP address and establishes a digital “paper trail” that can be collected, tracked, and monitored. The system discussed herein can collect, record, and generally observe these digital “paper trails” for a plurality of devices to perform disclosed the cross-device IP matching processes.

In at least one embodiment, the systems and processes disclosed herein are operatively configured to generate profiles for devices, such as the employee's device from the example discussed above. The device profiles can include various types of data, and more specifically the device profiles include data corresponding to actions performed at, on, or with the devices. Given electronic computing devices are typically assigned type of device ID), these device ID's are often shared by the device with a network host when requesting to join a Wi-Fi® network, and the device ID's may be also be included in information transmitted over the internet. Accordingly, in response to receiving a particular device ID, the system can identify the particular device ID within various data sources and data sets, and the system can furthermore develop a profile based on digital behavior corresponding to that device ID.

Moreover, and referring back to the restaurant employee example, the system can receive a first batch of data (such as de-identified user data) from the service or platform the employee used to place his/her order for pick-up, and the de-identified data can include information such as device ID's, order details, order timestamps, device location data (such as GPS data), IP addresses from which orders were placed, etc. In various embodiments, the system can receive a second batch of de-identified data from a separate service or platform, such as the mapping and transit application that the employee used to estimate his/her commute time, and the system can cross-reference the first and second batches of de-identified data to determine commonalities between the data. For example, by cross-referencing the first and second batches of de-identified data, and furthermore by receiving subsequent data batches, the system can determine that a device with a particular device ID connects to the internet via a particular public IP address at or around a particular time and always at or around a particular geographical location.

In response to generating profiles for devices, the system can furthermore determine a location of an “unknown” network device by receiving a public IP address associated with the device. For example, consider that the restaurant at which the employee works has a television which is an “unknown” device given the system currently has no data from the television on record, and the restaurant displays a sporting event on the television for its patrons. The system can receive (from the cable broadcasting service, or another entity) the public IP address associated with receiving the sporting event broadcast transmission, and furthermore compare the public IP address to the stored device profiles to determine if the device profiles include a record of the public IP address. In response to determining that a device profile, such as the employee's device profile, includes a record of using the public IP address for internet connectivity, the system can more granularly process the data within the device profile, namely the device activities performed while connected to the internet via the IP address. By processing data such as the device location data included within the restaurant employee's device profile, and given the data is associated with the same IP address associated with receiving the sporting event broadcast transmission, the system can determine that the “unknown” network device's location is the same as the restaurant employee's device at the time of the sporting event broadcast. Moreover, the system can compare the geographical coordinates corresponding to the employee's location data to map data, or the like. By comparing the coordinates to map data, the system can determine a particular establishment at which the television is located.

### Example Embodiments

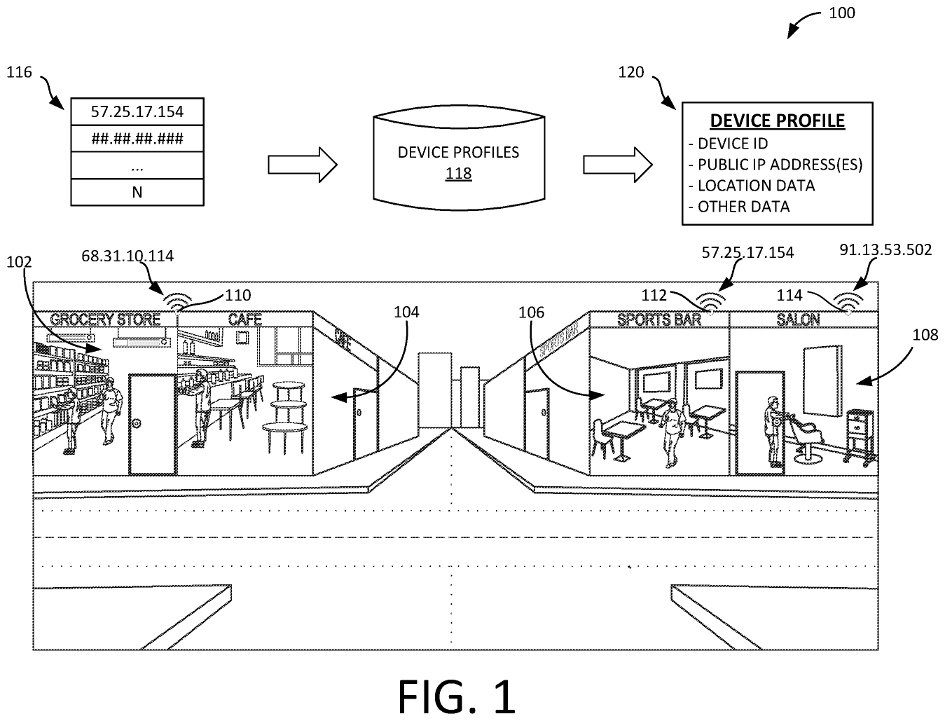

Referring now to the figures, for the purposes of example and explanation of the fundamental processes and components of the disclosed systems and processes, reference is made to FIG. 1, which is a diagram illustrating an example operational environment 100. As shown in FIG. 1, the example operational environment 100 is an urban roadway with multiple business establishments positioned near a traffic intersection. Specifically shown in FIG. 1 is a grocery store 102, a café 104, a sports bar 106, and a salon 108. Each of these establishments provides a network access point through which its patrons can establish an internet connection, for example, via their mobile computing devices.

As illustrated in FIG. 1, the grocery store 102 and café 104 can share a network access point 110. The network access point 110 shared between the grocery store 102 and café 104 can be shared network hardware, such as a modem, switch, router, etc., and the grocery store 102 and café 104 can maintain separate local area networks (e.g., Wi-Fi® networks, or the like) within their respective establishments. The network access point 110 can be assigned a public IP address (for example, by an ISP) for use during outbound communications with the internet, and this public IP address can be shared between both the grocery store 102 and café 104, such as the public IP address 68.31.10.114 as shown in FIG. 1. However, the grocery store 102 and café 104 can each use separate private IP address schemes within their private networks. For example, a router (or similar network hardware) associated with the network access point 110 and having a private IP address of 192.168.1.0 can manage two sub-networks by attributing the private IP addresses of 192.168.2.0 and 192.168.3.0 to those two sub-networks, respectively. Further, a device seeking to establish a network connection with the 192.168.2.0 IP address can be assigned the 192.168.2.1 private IP address. In this way, the network hardware at the network access point 110 can use a single public IP address for outbound internet communications, and the network hardware can then determine to which sub-network and devices in that sub-network any inbound internet communications should be routed. In certain examples, the network hardware may be configured with a subnet mask or the like for establishing sub-networks associated with a single network hardware component.

Still referring to FIG. 1, the sports bar 106 and salon 108 are illustrated as including separate network access points that are each dedicated to their respective establishments. In particular, the sports bar 106 includes a network access point 112, and the salon includes a network access point 114, both of which can be assigned separate public IP addresses. For example, the operational environment illustrated in FIG. 1 shows a public IP address of 57.25.17.154 in connection with the network access point 112, and a different public IP address of 91.13.53.502 in connection with the network access point 114. Accordingly, if a sports bar 106 patron was to connect his mobile computing device to the sports bar's Wi-Fi® network and subsequently access the internet from his device, the outbound network communications can include the public IP address 57.25.17.154 in its header packets. Likewise, if a salon 108 employee was to connect his mobile computing device to the sports bar's Wi-Fi® network (given the close geographical proximity between the establishments) and subsequently access the internet from his device, the outbound network communications can also include the public IP address 57.25.17.154 in its header packets. However, the salon 108 employee can also connect his device to the Wi-Fi® network at the salon 108, accessible via the network access point 114, and thus the salon 108 employee's outbound network communications can include the public IP address 91.13.53.502 in its header packets. As will be understood by one of ordinary skill in the art, IP addresses in network communications can indicate sources and destinations for the information being communicated.

Illustrated above the business establishments in FIG. 1 is a high-level depiction of the systems and processes that are operatively configured to perform the cross-device IP address matching as disclosed herein. In particular, the high-level depiction includes a three-step processing flow (simplified as illustrated for ease of discussion) that generally outlines a process by which the system (1) receives a list of public IP addresses 116, (2) compares the list of public IP addresses 116 to a database 118 including one or more device profiles to identify a device profile 120 that corresponds to a particular public IP address, and furthermore (3) determines a geographical location at which the particular public IP address is located based on historical location data in the device profile 120.

In at least one example, the list of public IP addresses 116 can be one or more IP addresses that are recorded as having received a particular stream or transmission of digital content. In various embodiments, any of the public IP addresses assigned to the network access points 110, 112, and 114, can be included in the list of public IP addresses 116 if the particular transmission of digital content was received by those network access points. In an example scenario, if the list of public IP addresses 116 includes IP addresses that are known to be associated with, or known to have received, a sporting event broadcast, and furthermore if the sports bar 106 displayed the sporting event on a television in the sports bar 106, the public IP address assigned to the network access point 112 (57.25.17.154) can appear on the list of public IP address 116.

Continuing with the example scenario in which the public IP address assigned to the sports bar's network access point 112 is included in the list of public IP addresses 116, the system can compare each IP address from the list of public IP addresses 116 to a plurality of device profiles stored in a device profile database 118 to determine if the public IP addresses are included in the device profiles. As will be discussed in greater detail throughout the present disclosure, the system can be operatively configured to generate (and continuously update) device profiles that include data received in connection with a unique device identifier, or device ID. The data in a device profile generally includes data that originated from activities performed at its respective device; however, the data need not be received from the device directly. For example, if a particular device includes an application (e.g., social media, ride sharing, travel, e-commerce, productivity, health tracking, etc.), the data can be received from third-party companies that provide and/or service those applications. In at least one example, internet-supported activities performed on a device, such as requesting services on a ridesharing application, can include data that identifies the specific device (i.e., a device ID), metadata corresponding to the activity or request (e.g., location data, timestamp, etc.), and also the public IP address servicing the network through which the device is connected to the internet. Moreover, this data can be received by the system and stored in a device profile corresponding to the device ID. As such, if a sports bar 106 patron connected his/her device to the internet via the network access point 112 and subsequently requested services on a ridesharing application while at the sports bar 106 and connected to its network, the system can receive the public IP address 57.25.17.154 assigned to the network access point 112 and associate the public IP address with the patron's device profile (the device profile 120, for example purposes). Accordingly, in response to the system comparing each IP address from the list of public IP addresses 116 to the devices profiles stored in the device profile database 118, the system can identify the patron's device profile 120 as a match.

In response to identifying the patron's device profile 120 as a match, the system can continue to process data associated with and/or stored in the device profile 120 to determine a geographical location at which the public IP address is located. In at least one example, the system can process data within the matched device profile 120 that is indicated as having been generated while using the public IP address 57.25.17.154 assigned to the network access point 112, and that data can include location data, timestamp data, etc. Accordingly, given the system can determine that the patron's device connected to the internet using the same public IP address to which the stream of digital content was transmitted, the system can process location data within the patron's device profile in connection with the public IP address to determine a geographical location at which the digital content was displayed. In at least one example, the systems and processes discussed herein solve the technical problem of determining a device's location based solely on its public IP address by matching the public IP address to data from other devices.

Given GPS location data transmitted by mobile computing devices (such as smart phones, smart watches, wearable technology, etc.) generally includes about a 3-5 meter radius of error with respect to preciseness of the location data, location data transmitted from a device located within the salon 108 could appear to the system during subsequent processing, based on the potential radius of error, to be located within the sports bar 106 given the device located within the salon 108 is likely within 3 to 5 meters of the sports bar 106 premises. In certain embodiments, the radius of error received from mobile computing devices can be as great as 400 meters (or larger), and so location data transmitted from a mobile computing device within a particular establishment can appear to the system to be located at other establishments that are not immediately physically adjacent to the particular establishment.

Embodiments of the systems and processes disclosed herein can also perform additional processing to determine a particular business establishment, located at or around a geographical location, to which a particular IP address belongs. In one example, the system can be operatively configured to process map data (and map metadata), which generally includes data corresponding to business establishments, residential dwellings, street names, etc., as would be illustrated on a digital map for a particular geographical region. For example, and still referring to FIG. 1, the salon 108 is located adjacent to the sports bar 106, and the two establishments are close enough in geographical proximity such that the location data may not be sufficient to confirm with certainty whether the particular IP address belongs to the sports bar 106 or salon 108. As mentioned above, given GPS location data from mobile computing devices generally includes a radius of error ranging from about 3 to 5 meters (although the radius of error can be as large as about 400 meters) location data received from a device located within the salon 108 could appear, based on the potential error, to be located within the sports bar 108 given the device located within the salon 108 is likely within 3 to 5 meters of the sports bar 106 premises. However, map data and map metadata can include an indication of the establishment type, hours of operation, peak hours, etc., which can be compared to metadata from the stream of digital content to determine which establishment is most likely to be the owner (or assignee) of the public IP address. In particular, if certain digital content is recorded as being transmitted to the public IP address during evening hours, and map data indicates that the salon 108 operates under normal business hours, and map data also indicates that the sports bar 106 is open and typically busy in the evening, the system can determine that the sports bar 106 is most likely to be the IP address owner.

In another example, the system can process metadata associated with the particular stream of digital content when determining which establishment is the IP address owner. In particular, the system can process metadata from the stream of digital content to determine that the digital content is a sports broadcast, and thus determine that the sports bar is more likely than the salon to be the IP address owner.

In at least one example, the system can generate “place profiles,” which are data structures like the device profiles; however, the place profiles can include data received in connection with establishments. For example, and in response to receiving map data and metadata, as well as in response to detecting a stream of digital content received at an establishment, the system can process the map data and/or metadata, the metadata from the stream of digital content, and also data corresponding to a plurality of devices associated with the establishment, to determine whether a particular establishment's observed behavior resembles other known establishments, if a particular establishment's observed behavior resembles a bar such that peak hours are typically in the evening, or rather if a particular establishment's observed behavior resembles a nail salon such that peak hours are typically during daytime business hours. These determinations can be stored in connection with an establishment's place profile and can be used when matching subsequently received IP address to establishments.

In another example, the system can be operatively configured to determine if a plurality of devices are associated with a particular public IP address, and the system can furthermore generate a digital cluster representative of each device with location data corresponding to the public IP address. In this example, if the digital cluster representative of each device and the device's location data favors the geographical coordinates for the sports bar 106 over the salon 108 (such that the average location for the plurality of devices is closer to the sports bar 106 coordinates), the system may determine that the sports bar 106 is the IP address owner.

In another example, the system can generate “scores” for devices profiles that represent a likelihood, based on other data in the device profile, that a particular device's known behavior while connected to a public IP address is sufficient for the system to confidently determine the IP address's owner and location. In particular, consider a sports bar 106 employee's device profile that includes information about the employee's device and how the device consistently connects to the sports bar's 106 public IP address (57.25.17.154) during evening hours, while the salon 108 is closed. By processing this data in the employee's device profile, the system can confirm with high probability that the public IP address belongs to the sports bar 106, and not the salon 108.

In another example, multiple establishments may share network hardware and the system can determine to which establishment a particular stream of digital content should be attributed to. Consider the network access point 110 shown in FIG. 1, which is shared by the grocery store 102 and the café 104. In this example, the grocery store 102 and café 104 can share a common public IP address 68.31.10.114; however, the grocery store 102 and the café 104 may maintain separate sub-networks in which both the grocery store and café can use different schemes for assigning private IP addresses to device connected to their respective sub-networks. In response to receiving data generated by devices connected to the grocery store 102 and café 104 sub-networks, the system can process the metadata in the device profiles to determine which establishment (the grocery store 102 or the café 104) is most likely to have received a particular stream of digital content directed towards the shared public IP address.

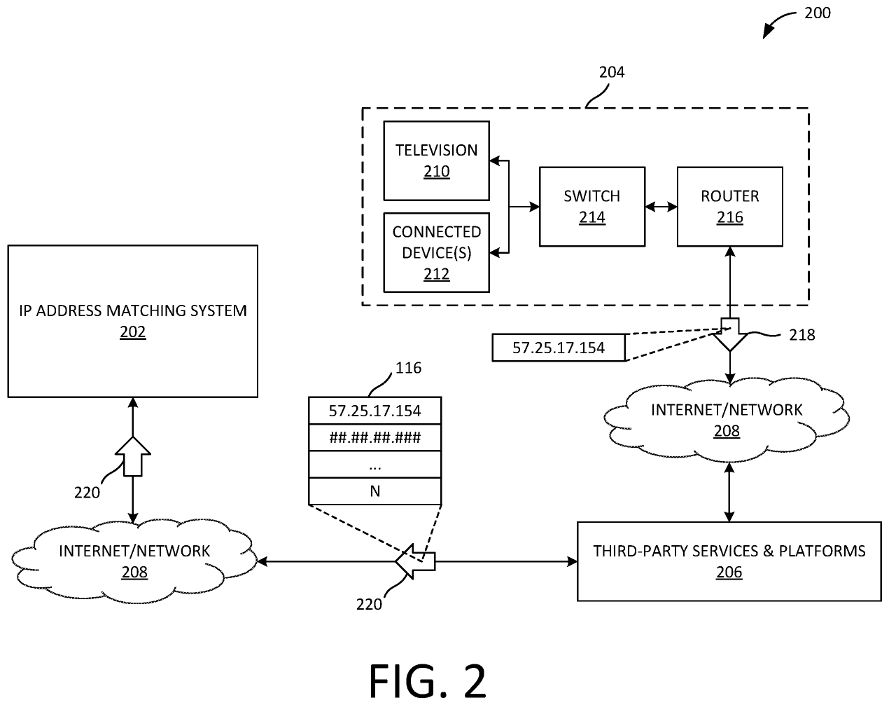

Proceeding now to FIG. 2, a diagram is shown illustrating a technical operational environment 200 for an IP address matching system 202 as discussed in the present disclosure. In at least one example, the technical operational environment 200 illustrates the IP address matching system 202 as being operatively connected to an establishment system 204, as well as to third-party services and platforms 206, over an internet 208 (or other appropriate network) connection. The establishment system 204 is shown as including a television 210 and one or more connected devices 212, and the television 210 and connected devices 212 are furthermore connected to a switch 214 and/or a router 216, through which the television 210 and connected devices 212 can establish internet connections (or receive data via the internet). However, notwithstanding the depiction of the television 210, the connected devices 212, the switch 214, and the router 216, it should be understood that the establishment system 204 hardware as shown is depicted for example purposes only, and the establishment system 204 can include other appropriate network hardware not currently depicted.

The television 210 can be a “smart” television, such that the television 210 can establish internet connections via hardware at the television 210 for receiving streams of digital content. However, the television 210 can also be a traditional television that receives content via additional hardware as provided by broadcast television companies. In general, the television 210 can be any device capable of receiving and/or displaying digital content. Moreover, it should be understood that reference to a television as discussed herein is for purposes of example is not intended to limit the scope of the disclosed embodiments to a particular television or device. For example, in particular embodiments, the television 210 can be a “smart” television as discussed above, or the television 210 can be a tablet, computer, Internet or Things (IoT) device, embedded computing device, edge device, smart appliance screen, projector, etc., and generally any device that is capable of receiving and/or displaying content. The router 216 can be operatively connected to the internet 208 via one or more internet service providers. Moreover, the internet service providers that support the internet 208 connection can assign the router 216 a public IP address. Thus, outbound internet communications from the router 216 will include the public IP address as a source indicator. The router 216 can, in turn, assign the television 210 and the devices 212 private IP addresses, and the switch 214 can assist in delivering data payloads within the establishment system 204, as appropriate.

Continuing with the discussion of FIG. 2, an IP data packet 218 is shown being transmitted outwardly from the establishment system 204. In at least one example, the data packet 218 can be a request for receiving a particular stream of digital content, and the request can be transmitted from the router 216 or other appropriate network hardware at the establishment system 204. Moreover, a header in the IP data packet 218 can include a public IP address assigned to the router 216. As shown in FIG. 2, an example public IP address included in the IP data packet is “57.25.17.154.” In at least one example, the IP data packet 218 transmitted outwardly from the establishment system 204 can also include the destination IP address and a packet payload (the actual intended message in the IP data packet).

The third-party services and platforms 206 can receive the IP data packet 218 and, in response to processing the packet and payload, transmit back to the establishment system 204 a particular stream of content as requested in the IP data packet 218. In response to receiving and processing the IP data packet 218, the third-party services and platforms 206 can record the public IP address included in the IP data packet, 57.25.17.154, as being associated with requesting and/or receiving the particular stream of content. In at least one example, the third-party services and platforms 206 can transmit a data batch 220 to the IP address matching system 202, and the data batch 220 can include a list of public IP addresses 116 associated with requesting and/or receiving the particular stream of content. As shown in FIG. 2, the list of public IP addresses 116 can include the public IP address 57.25.17.154 as assigned to the router 216 given a request for the particular stream of content originated from the router 216.

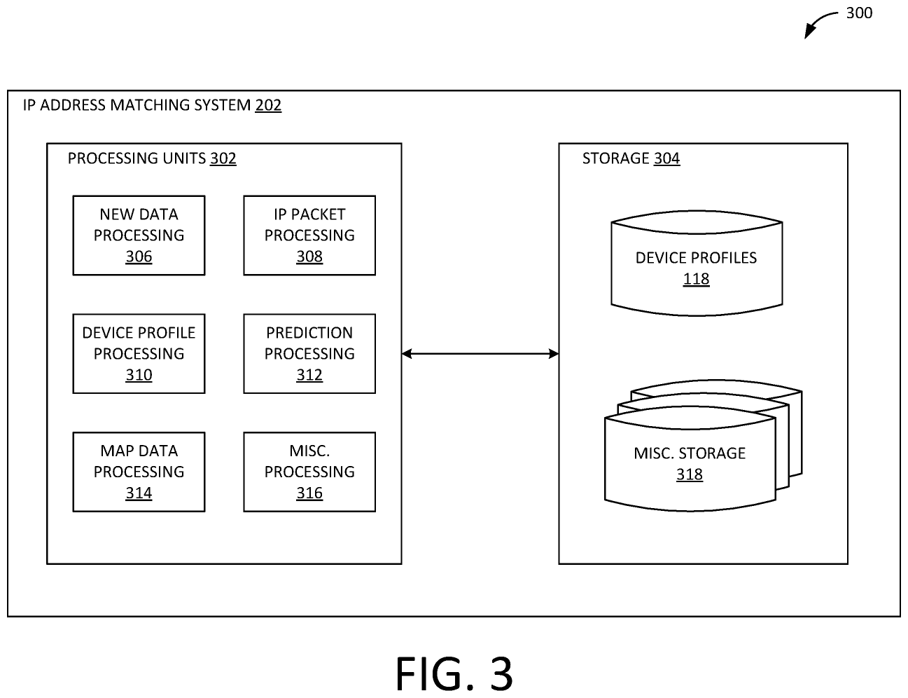

FIG. 3 is a diagram 300 illustrating an example technical architecture of the IP address matching system 202. As shown in the diagram 300, the IP address matching system 202 can include at least a combination of processing units and data storage, and the IP address matching system 202 can be operatively configured to not only process device data received from external sources (such as the third-party services and platforms 206), but also the IP address matching system 202 can be operatively configured to continuously process previously received and previously processed device data for determining new relationships between all data in the system. In at least one example, the IP address matching system 202 can perform extract, transform, and load (ETL) processing on the device data to combine the device data as received from multiple sources and represent the device data in a single unified data repository.

The data processing units 302 can include one or more processors that are operatively configured to perform the IP address matching processes discussed herein. In at least one example, the data processing units 302 can include a new data processing unit 306, an IP packet processing unit 308, a device profile processing unit 310, a prediction processing unit 312, and a map data processing unit 314. The data processing units 302 can be a dynamically scalable system, and can therefore adjust and/or augment to its configuration as appropriate. This ability to adjust and/or augment to the data processing unit 302 configuration is represented in the diagram 300 as a miscellaneous processing unit 316.

The new data processing unit 306 can be operatively configured to receive, for example, the data batches transmitted to the system by various third-party services and platforms, and the new data processing unit 306 can furthermore process the data batches. In at least one example, the new data processing unit 306 can process a newly received list of public IP addresses (that correspond to a stream of digital content) to public IP addresses in the device profiles stored in the device profiles database 118.

The IP packet processing unit 308 can be operatively configured to process IP packets to determine the information (metadata) transmitted within the IP packets. For example, the IP packet processing unit 308 can be operatively configured to process IP packets corresponding to a particular stream of digital content to determine that digital content corresponds to a sports broadcast.

The device profile processing unit 310 can be operatively configured to generate new device profiles, and to furthermore process data within device profiles. In at least one example, the device profile processing unit 310 can be configured to compare data between device profiles to determine relationships between the profiles.

The prediction processing unit 312 can be operatively configured to generate predictions corresponding to devices and based on their respective device profiles. For example, in response to the device profile processing unit 310 determining that a particular device established an internet connection with a particular public IP address, the prediction processing unit 312 can identify if the particular device establishing the internet connection becomes a pattern such that the prediction processing unit 312 can (with relative certainty) determine if and when a device will exhibit the same behavior again.

The map data processing unit 314 can be operatively configured to process map data corresponding to location data in a device profile. For example, the map data processing unit 314 can be configured to receive map data from a service or platform such as Google® Maps® and furthermore compare a device's location data to the map data to determine an establishment at which the device was likely present.

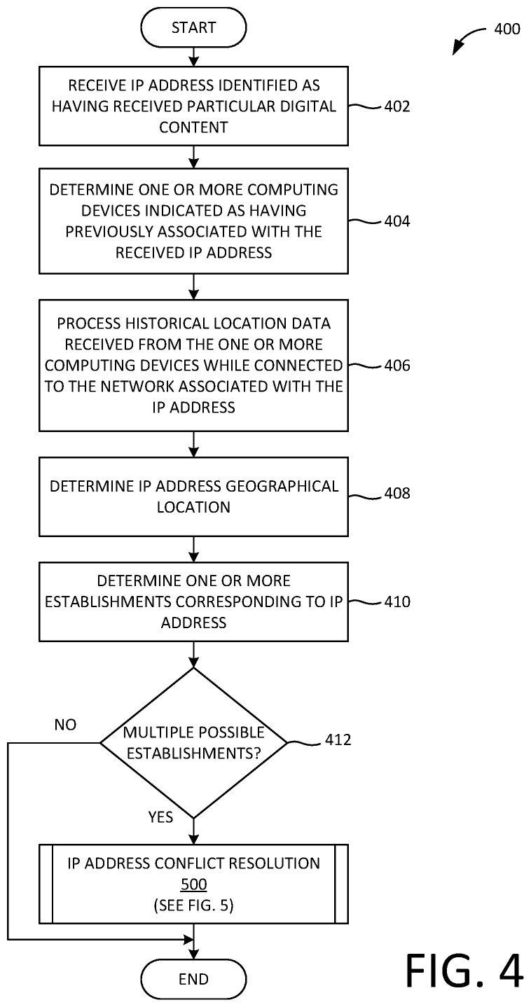

FIG. 4 is a flowchart of an example cross-device IP address matching process 400. The cross-device IP address matching process 400, as discussed throughout the present disclosure, is a process by which system can receive an IP address and furthermore determine an establishment that is the likely owner of the IP address by processing location data from one or more computing devices indicated as having previously associated with the IP address.

The example cross-device IP address matching process 400 can begin at step 402, where the system receives an IP address. In at least one example, the IP address can be a public IP address, or a list of public IP addresses, identified as having received particular digital content. In various embodiments, the list of public IP addresses can be indicated as having received, for example, a television broadcast (or digital content stream) of a sporting event, and the system can receive the list of public IP addresses from the broadcaster or content provider (e.g., Comcast®, NBC®, etc.). In other examples, the list of IP address can be received from the manufacturers of the devices that receive the content, such as Roku® or Samsung®.

At step 404, the system determines one or more computing devices indicated as having previously associated with the IP address received at step 402. As discussed throughout the present disclosure, the system can maintain device profiles for generally any networked computing device, and the device profiles can be cataloged according to each device's unique device identifier. For a device to establish an internet connection via a network access point, the device typically shares its unique device identifier with the network access point so that the network access point can assign the device a private IP address. As devices connect to network access points and the device owners continue to use applications on the devices while connected to the network access points, the devices generate data trails that can include information such as the unique device ID and the public IP address through which communications through the internet are routed, and these data trails are stored in the device profiles for their respective computing devices.

Accordingly, in at least one example, the system can determine if one or more computing devices are indicated as having previously associated with the public IP address based on the one or more computing devices sharing their unique device identifiers to be assigned a private IP address for accessing the network access point.

At step 406, the system can process historical data received from the computing devices. In at least one example, the historical data can be location data received from the computing device while connected to the network associated with the IP address received at step 402. In response to determining computing devices indicated as having previously associated with the IP address, the system can determine within their respective device profiles the data generated by those computing devices while connected to a network associated with the IP address, given the IP address can be included in the device data trails. Moreover, the data generated by the computing devices while connected to the network associated with the IP address can include location data indicative of the computing devices' geographical coordinates and corresponding timestamps. For example, the location data can include longitude and latitude coordinates of the computing device. The system can also process device movement data, such as data from a device's accelerometer or a similar sensor, that can indicate if a device is in a stationary position (such as resting on a desk), or if a device is in a bag, pocket, etc. In another example, device movement can be determined based on comparing a plurality of location data points over time (for example, GPS location data points) to determine if a mobile computing device's location appears to be relatively stationary, or if a mobile computing device's location appears to be changing substantially (such as 60 mph if the mobile computing device was located within a moving automobile). In at least one example, historical data can include signal data, such as a received signal strength indicator (RSSI), a received channel power indicator (RCPI), or a similar signal strength indicator. Signal strength indicators are numerical representations of an amount of power present in a received signal, commonly represented as decibels relative to milliwatts (dBm's) and measured on a scale of −30 dBm to −100 dBm (where −30 dBm is strongest). Accordingly, if two separate computing devices are recorded as being connected to the network associated with the IP address and furthermore that the signal strengths for both computing devices is strong (for example, greater than −80 dBm), the system can determine that the two computing devices were at the same geographical location while connected to the network. If an RSSI is greater than a predetermined threshold, such as −80 dBm, −75 dBm, −70 dBm, etc., the system can determine that the corresponding computing device receiving the signal is physically proximate to the geographical coordinates of the IP address and the establishment at which it is located.

Proceeding now to step 408, the system can determine a geographical location corresponding to the IP address. In at least one example, determining a geographical location corresponding to the IP address can include determining specific geographical coordinates at which the IP address is located. In other examples, determining a geographical location corresponding to the IP address can include determining a general location, based on the processed historical location data from step 406, at which the IP address is located. The general location can be a geographical region within which an owner of the IP address is likely located. The system can determine a location at which an owner of the IP address is located based on, for example, a frequency, time duration, or pattern associated with the devices connecting to the IP address, whether a plurality of device profiles include substantially similar location data, etc. In at least one embodiment, the system can generate “place profiles” for establishments (as briefly discussed above in connection with FIG. 1) based on detected or observed establishment characteristics such as hours of operation, peak hours, particular types of content received at (or streamed by) the establishment, etc. In general, map data and metadata, as well as metadata associated with content received at an establishment, can be used to populate a place profile.

At step 410, the system can determine the one or more establishments corresponding to the IP address. Determining one or more establishments corresponding to the IP address can include comparing the geographical location, as determined at step 408, to map data. Map data can include real-world contextual information that corresponds to geographical locations and coordinates. For example, while a geographical location or coordinates can represent a specific geographical point in a city, map data can represent contextual information such as businesses, residences, establishments, street names, etc., at or around the geographical location or coordinates. In at least one example, map data associated with a particular establishment can include information such as the establishment's physical addresses, also commonly referred to as its street addresses, which further corresponds to longitudinal and latitudinal coordinates for the establishment. Accordingly, and in response to determining a geographical location at which the IP address owner is located, the system can furthermore compare the geographical location to map data to determine an establishment with a physical address that corresponds to longitudinal and latitudinal coordinates that are substantially the same as the geographical location. Moreover, the system can determine that two sets of geographical coordinates are substantially the same, or that they are physically proximate, if the geographical coordinates are within a predetermined distance from each other. For example, the predetermined distance can be 3 meters, 5 meters, 10 meters, 15 meters, 20 meters, 50 meters, etc. In certain scenarios, the system can determine that the predetermined distance should be 50 meters instead of 3 meters if the system determines (based on the map data) that the establishment is, for example, a warehouse instead of coffee shop with a smaller geographical footprint. In at least one example, the geographical footprint for each establishment can be represented within the system as a geometric shape including a circle, a polygon or similar geometric shape corresponding to its physical boundaries, leasable space, accessory spaces such as parking lots, etc. In particular embodiments, representing an establishment's geographical footprint as a geometric shape can include indicating a plurality of geographical coordinates (such as latitude and longitude points) as vertexes, corners, or general boundary points, and the area enclosed by the edges connecting the polygon vertexes corresponds to the establishment's geographical footprint. This geometric shape information can be processed or extracted from map metadata. In some embodiments, the system can retrieve this information from publicly available databases such as property records. The system can compare these geometric shapes to the geographical location associated with an IP address. In some embodiments, when the geographical location associated with the IP address falls within (or is enclosed by) the boundaries of a particular geometric shape, the system can determine that the IP address belongs to the establishment corresponding to that particular geometric shape. In some embodiments, when a geometric shape corresponding to the geographical location associated with the IP address intersects with one or more boundaries of a particular geometric shape, the system can determine that the IP address belongs to the establishment corresponding to that particular geometric shape. In some embodiments, when the geographical location associated with the IP address is within a predefined distance from one or more boundaries of a particular geometric shape, the system can determine that the IP address belongs to the establishment corresponding to that particular geometric shape.

In at least one example, at step 412, the system determines in response to the step 410 above whether multiple establishments share coordinates that are substantially the same as the IP address's geographical location. Consider a scenario in which two establishments are neighboring establishments such that their respective geographical locations are generally the same. In response to processing map data, the system can identify this scenario and furthermore determine if additional processing is appropriate for determining the specific establishment at which the IP address owner is located. As discussed briefly above, determining if there are multiple possible establishments at step 412 can include processing map data to determine if more than one establishment are located at or around the geographical location determined at step 408. The system can also determine if there are multiple possible establishments at step 412 based on information included in the device profiles as processed at step 406.

If the system determines that there are not multiple possible establishments, the process 400 can terminate. However, if at step 412 the system determines that there are multiple possible establishments, the process 400 can continue to the IP address conflict resolution process 500, which is discussed in greater detail immediately below.

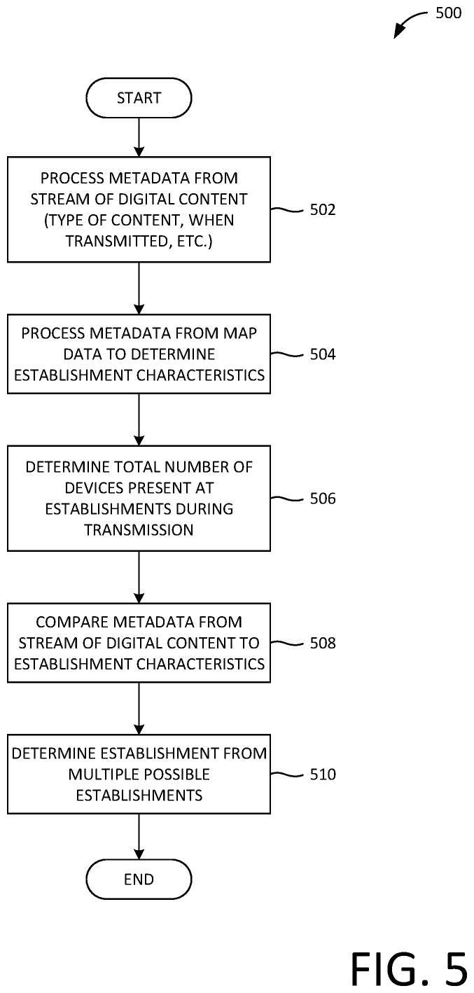

FIG. 5 is a flowchart of an example IP address conflict resolution process 500. As mentioned above in association with the discussion of step 412 of the process 400, the system can determine that more than one establishments include geographical coordinates that are substantially the same as, or located in close physical proximity to, the IP address's geographical location such that further processing is appropriate for determining the specific establishment at which the IP address's owner is located. If another establishment's geographical coordinates are within a predetermined distance of the IP address's geographical location, such as 3 meters, 5 meters, 10 meters, 15 meters, the system can determine that the establishments are physically proximate such that further processing is appropriate for determining the specific establishment at which the IP address's owner is located. In higher density areas like cities where multiple establishments share a common building, the predetermined distance can be a smaller threshold value such as 5 meters; however, the predetermined distance can be expanded as appropriate for lower density areas. In at least one example, via the process 500, the system can process metadata from at least the particular stream of content, map data, and data included in device profiles, to reach a determination that the IP address corresponds to a particular establishment, and not one or more other possible establishments.

The process 500 can begin at step 502, wherein the system processes metadata from the stream of digital content associated with the IP address (or list of IP addresses) received at step 402 of the processes 400, as discussed above. In at least one example, the metadata can include information such as content type, transmission timestamps, etc., which can indicate characteristics about the recipient of the stream of content. For example, if metadata corresponding to a television broadcast included information that indicated the broadcast was an evening professional sporting event, that metadata would be helpful in determining whether, for example, a sports bar or a hair salon received the broadcast.

At step 504, the system can determine respective characteristics for the multiple establishments. In at least one example, the system can process metadata from the map data to determine the respective characteristics, which can include information such as hours of operation, business type, high-traffic hours, or any other information that may be included in the map data. In a particular example, the system can retrieve the metadata from the map data via API calls to the service or platform from which the map data was initially received. In another example, the system can retrieve the metadata from the map data via scraping a web page on corresponding to the map data.

At step 506, the system can determine a total number of devices present at the establishments at and around the time when the stream of digital content associated with the IP address was received. For example, consider a scenario in which, at the time when the stream of digital content associated with the IP address was received, a plurality of computing devices were identified as being present at a sports bar (such as the sports bar 106), and zero computing devices were identified as being present at a neighboring hair salon (such as the salon 108). Despite the sports bar and the nail salon having similar geographical locations, location data from other devices and metadata within that location data can indicate to which establishment an IP address belongs. Accordingly, the system can perform “event profiling,” which includes determining a particular establishment that is most likely to correspond to an IP address based on characteristics observed from the establishment (e.g., hours of operation, observed peak hours, etc.). In one example, if a particular stream of content was received at an establishment on a Sunday evening, and a plurality of mobile computing devices were identified as being present at the establishment, the system could determine that the particular stream of content is a sporting event and is being shown at a sports bar (and not at a neighboring salon).

At step 508, the system can compare metadata from the stream of digital content to the metadata from the map data (e.g., establishment characteristics) to determine whether a particular establishment from the multiple possible establishments can be attributed to the received IP address. Consider again the example in which the system is determining whether an IP address associated with a particular stream of digital content belongs to a sports bar or a hair salon. In this example, the metadata from the particular stream of digital content can include timestamps corresponding to packet transmissions, and the metadata from the map data can include operating hours for both the sports bar and the salon. By comparing the packet transmission timestamps to the hours of operation, the system can determine that the sports bar likely received the stream of digital content given the sports bar was open when the stream of digital content was transmitted, and further given the hair salon was closed.

Accordingly, and in response to comparing metadata from the stream of digital content to metadata from the map data, at step 510 the system can determine a particular establishment, from the multiple possible establishments, to which an IP address belongs.

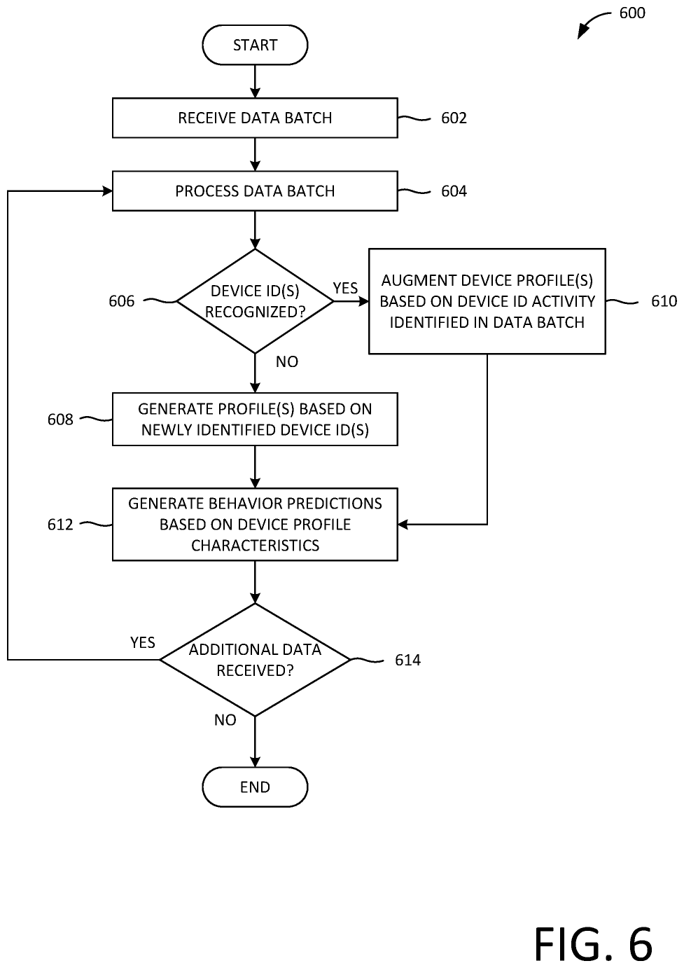

FIG. 6 is a flowchart of an example data ingestion process 600. The process 600 can begin at step 602 where the system receives a data batch. In one example, a data batch can be de-identified data from third-party services or platforms which provide mobile applications. For example, the data batch can include de-identified user data from a particular application based on the prior month's application usage, as collected from the application's user base. The data batch can generally be any type of data and can be current such that there is little delay between when a user generated the data via his/her device to when the system received the data in the data batch.

At step 604, the system can process the data batch. Processing the data batch can include merging the data batch with preexisting data, rebuilding or correcting for missing data, data normalization or standardization, data de-duplication, data verification, etc. The system can perform extract, transform, load (ETL) processing, or other similar types of large scale data processing techniques, on the data batch. In at least one example, processing the data batch includes identifying one or more device ID's within the data batch that match or correspond to device ID's within the stored device profiles.

At step 606, the system determines whether a device ID within the data batch matches with or corresponds to a device ID within the stored device profiles. Given device ID's are generally unique identifiers assigned to devices by their respective manufacturers, the system can determine that a device ID within the data batch and a matching device ID from a stored device profile correspond to the same device.

If at step 606 the system identifies a device ID from the data batch that is not recognized, such that the identified device ID does not match with a device ID currently within a stored device profile, the process 600 can proceed to step 608 where the system generates a new device profile for the identified device ID. In one example, step 608 represents the system receiving and identifying data generated from a computing device that is not yet being monitored by the system.

If at step 606 the system identifies a device ID from the data batch that is recognized such that the device ID matches a device currently within a stored device profile, the process 600 can process to step 610 where the system augments the stored device profile based on the device activity corresponding to the device ID from the data batch. In at least one example, augmenting the stored device profiles can include adding newly identified device location data to the device profile, as identified within the data batch.

Both steps 608 and 610 can proceed to step 612, where the system generates behavioral predictions based on device profiles characteristics. As discussed throughout the present disclosure, and in response to generating device profiles, the system is operatively configured to generate behavioral predictions for the devices based on the data included in their respective device profiles. In at least one example, generating a prediction for one or more devices relates to generating a confidence score corresponding to one or more aspects of their device profiles. For example, if a plurality of devices, independently from each other, travel to a particular location every weekday and remain at the particular location during business hours, the system can identify this pattern, determine that the plurality of devices likely belong to individuals that work at an establishment at the particular location, and the system may furthermore generate a confidence score indicative of the identified pattern. The system can generate predictions and confidence scores for generally any aspect of a device profile. In at least one example, the system can also leverage machine learning and artificial intelligence to identify patterns within and between device profiles.

At step 614, the system determines whether additional data (such as a new data batch) has been received that may require processing. If additional data was received and additional processing is appropriate, the process 600 may return to the step 604. However, if no additional data was received, the process 600 may end.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media, such a tangible, non-transitory, computer-readable medium, for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another

communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

Clause 1. A method comprising: receiving an internet protocol (IP) address corresponding to a recipient device; determining one or more mobile computing devices associated with the IP address, wherein the one or more mobile computing devices are indicated as having previously established an internet connection via the IP address; processing historical data received from the one or more mobile computing devices, wherein the historical data comprises location data identifying geographical coordinates at which the one or more mobile computing devices were located while connected to the internet via the IP address; and determining an establishment at which the recipient device is located based on the geographical coordinates, wherein the establishment is located physically proximate to the geographical coordinates.

Clause 2. The method of clause 1 or any other clause herein, wherein the one or more mobile computing devices being indicated as having previously established an internet connection via the IP address comprises detecting a unique device identifier, for each of the one or more mobile computing devices, in internet communications routed via the IP address.

Clause 3. The method of clause 1 or any other clause herein, wherein determining an establishment at which the recipient device is located further comprises comparing the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

Clause 4. The method of clause 3 or any other clause herein, wherein determining an establishment at which the recipient device is located further comprises: in response to comparing the geographical coordinates to the map data, determining the establishment and at least one other establishment are within a predetermined distance from the geographical coordinates; further processing the historical data, wherein the historical data further comprises time data indicative of a time duration during which the one or more mobile computing devices were connected to the internet via the IP address; processing the metadata corresponding to the map data, wherein the metadata corresponding to the map data further comprises hours of operation corresponding to the establishment and the at least one other establishment; and determining the time duration is outside the hours of operation corresponding to the at least one other establishment.

Clause 5. The method of clause 4 or any other clause herein, wherein receiving an IP address corresponding to a recipient device further comprises receiving metadata corresponding to a transmission of digital content, the metadata comprising at least a transmission timestamp, and wherein determining an establishment at which the recipient device is located further comprises determining the transmission timestamp is outside the hours of operation corresponding to the at least one other establishment.

Clause 6. The method of clause 5 or any other clause herein, wherein the IP address corresponding to the recipient device is received from a third-party entity associated with the transmission of the digital content.

Clause 7. The method of clause 1 or any other clause herein, wherein the historical data is received from applications running on the one or more mobile computing devices.

Clause 8. A system comprising at least one processor, wherein the at least one processor is operatively configured to: receive an internet protocol (IP) address corresponding to a recipient device; determine one or more mobile computing devices associated with the IP address, wherein the one or more mobile computing devices are indicated as having previously established an internet connection via the IP address; process historical data received from the one or more mobile computing devices, wherein the historical data comprises location data identifying geographical coordinates at which the one or more mobile computing devices were located while connected to the internet via the IP address; and determine an establishment at which the recipient device is located based on the geographical coordinates, wherein the establishment is located physically proximate to the geographical coordinates.

Clause 9. The system of clause 8 or any other clause herein, wherein the one or more mobile computing devices being indicated as having previously established an internet connection via the IP address comprises detecting a unique device identifier, for each of the one or more mobile computing devices, in internet communications routed via the IP address.

Clause 10. The system of clause 8 or any other clause herein, wherein determining an establishment at which the recipient device is located further comprises comparing the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

Clause 11. The system of clause 10 or any other clause herein, wherein determining an establishment at which the recipient device is located further comprises: in response to comparing the geographical coordinates to the map data, determining the establishment and at least one other establishment are within a predetermined distance from the geographical coordinates; further processing the historical data, wherein the historical data further comprises time data indicative of a time duration during which the one or more mobile computing devices were connected to the internet via the IP address; processing the metadata corresponding to the map data, wherein the metadata corresponding to the map data further comprises hours of operation corresponding to the establishment and the at least one other establishment; and determining the time duration is outside the hours of operation corresponding to the at least one other establishment.

Clause 12. The system of clause 11 or any other clause herein, wherein receiving an IP address corresponding to a recipient device further comprises receiving metadata corresponding to a transmission of digital content, the metadata comprising at least a transmission timestamp, and wherein determining an establishment at which the recipient device is located further comprises determining the transmission timestamp is outside the hours of operation corresponding to the at least one other establishment.

Clause 13. The system of clause 12 or any other clause herein, wherein the IP address corresponding to the recipient device is received from a third-party entity associated with the transmission of the digital content.

Clause 14. The system of clause 8 or any other clause herein, wherein the historical data is received from applications running on the one or more mobile computing devices.

Clause 15. A tangible, non-transitory, computer-readable medium comprising instructions encoded therein, wherein the instructions when executed by a processor, cause the processor to: receive an internet protocol (IP) address corresponding to a recipient device; determine one or more mobile computing devices associated with the IP address, wherein the one or more mobile computing devices are indicated as having previously established an internet connection via the IP address; process historical data received from the one or more mobile computing devices, wherein the historical data comprises location data identifying geographical coordinates at which the one or more mobile computing devices were located while connected to the internet via the IP address; and determine an establishment at which the recipient device is located based on the geographical coordinates, wherein the establishment is located physically proximate to the geographical coordinates.

Clause 16. The tangible, non-transitory, computer-readable medium of clause 15 or any other clause herein, wherein the one or more mobile computing devices being indicated as having previously established an internet connection via the IP address comprises the instructions, when executed by the processor, further causing the processor to detect a unique device identifier, for each of the one or more mobile computing devices, in internet communications routed via the IP address.

Clause 17. The tangible, non-transitory, computer-readable medium of clause 15 or any other clause herein, wherein determining an establishment at which the recipient device is located further comprises the instructions, when executed by the processor, further causing the processor to compare the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

Clause 18. The tangible, non-transitory, computer-readable medium of clause 17 or any other clause herein, wherein determining an establishment at which the recipient device is located further comprises the instructions, when executed by the processor, further causing the processor to: in response to comparing the geographical coordinates to the map data, determine the establishment and at least one other establishment are within a predetermined distance from the geographical coordinates; further process the historical data, wherein the historical data further comprises time data indicative of a time duration during which the one or more mobile computing devices were connected to the internet via the IP address; process the metadata corresponding to the map data, wherein the metadata corresponding to the map data further comprises hours of operation corresponding to the establishment and the at least one other establishment; and determine the time duration is outside the hours of operation corresponding to the at least one other establishment.

Clause 19. The tangible, non-transitory, computer-readable medium of clause 18 or any other clause herein, wherein receiving an IP address corresponding to a recipient device further comprises the instructions, when executed by the processor, further causing the processor to receive metadata corresponding to a transmission of digital content, the metadata comprising at least a transmission timestamp, and wherein determining an establishment at which the recipient device is located further comprises the instructions, when executed by the processor, further causing the processor to determine the transmission timestamp is outside the hours of operation corresponding to the at least one other establishment.

Clause 20. The tangible, non-transitory, computer-readable medium of clause 19 or any other clause herein, wherein the IP address corresponding to the recipient device is received from a third-party entity associated with the transmission of the digital content.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure. The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A method comprising:
receiving an internet protocol (IP) address corresponding to a recipient device;
determining one or more mobile computing devices associated with the IP address, wherein the one or more mobile computing devices are indicated as having previously established an internet connection via the IP address;
processing historical data received from the one or more mobile computing devices, wherein the historical data comprises location data identifying geographical coordinates at which the one or more mobile computing devices were located while connected to the internet via the IP address; and
determining an establishment at which the recipient device is located based on the geographical coordinates, wherein the establishment is located physically proximate to the geographical coordinates.

2. The method of claim 1, wherein the one or more mobile computing devices being indicated as having previously established an internet connection via the IP address comprises detecting a unique device identifier, for each of the one or more mobile computing devices, in internet communications routed via the IP address.

3. The method of claim 1, wherein determining an establishment at which the recipient device is located further comprises comparing the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

4. The method of claim 3, wherein determining an establishment at which the recipient device is located further comprises:
in response to comparing the geographical coordinates to the map data, determining the establishment and at least one other establishment are within a predetermined distance from the geographical coordinates;
further processing the historical data, wherein the historical data further comprises time data indicative of a time duration during which the one or more mobile computing devices were connected to the internet via the IP address;
processing the metadata corresponding to the map data, wherein the metadata corresponding to the map data further comprises hours of operation corresponding to the establishment and the at least one other establishment; and
determining the time duration is outside the hours of operation corresponding to the at least one other establishment.

5. The method of claim 4, wherein receiving an IP address corresponding to a recipient device further comprises receiving metadata corresponding to a transmission of digital content, the metadata comprising at least a transmission timestamp, and wherein determining an establishment at which the recipient device is located further comprises determining the transmission timestamp is outside the hours of operation corresponding to the at least one other establishment.

6. The method of claim 5, wherein the IP address corresponding to the recipient device is received from a third-party entity associated with the transmission of the digital content.

7. The method of claim 1, wherein the historical data is received from applications running on the one or more mobile computing devices.

8. A system comprising at least one processor, wherein the at least one processor is operatively configured to:
receive an internet protocol (IP) address corresponding to a recipient device;
determine one or more mobile computing devices associated with the IP address, wherein the one or more mobile computing devices are indicated as having previously established an internet connection via the IP address;
process historical data received from the one or more mobile computing devices, wherein the historical data comprises location data identifying geographical coordinates at which the one or more mobile computing devices were located while connected to the internet via the IP address;
and determine an establishment at which the recipient device is located based on the geographical coordinates, wherein the establishment is located physically proximate to the geographical coordinates.

9. The system of claim 8, wherein the one or more mobile computing devices being indicated as having previously established an internet connection via the IP address comprises detecting a unique device identifier, for each of the one or more mobile computing devices, in internet communications routed via the IP address.

10. The system of claim 8, wherein determining an establishment at which the recipient device is located further comprises comparing the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

11. The system of claim 10, wherein determining an establishment at which the recipient device is located further comprises:
in response to comparing the geographical coordinates to the map data, determining the establishment and at least one other establishment are within a predetermined distance from the geographical coordinates;
further processing the historical data, wherein the historical data further comprises time data indicative of a time duration during which the one or more mobile computing devices were connected to the internet via the IP address;
processing the metadata corresponding to the map data, wherein the metadata corresponding to the map data further comprises hours of operation corresponding to the establishment and the at least one other establishment; and
determining the time duration is outside the hours of operation corresponding to the at least one other establishment.

12. The system of claim 11, wherein receiving an IP address corresponding to a recipient device further comprises receiving metadata corresponding to a transmission of digital content, the metadata comprising at least a transmission timestamp, and wherein determining an establishment at which the recipient device is located further comprises determining the transmission timestamp is outside the hours of operation corresponding to the at least one other establishment.

13. The system of claim 12, wherein the IP address corresponding to the recipient device is received from a third-party entity associated with the transmission of the digital content.

14. The system of claim 8, wherein the historical data is received from applications running on the one or more mobile computing devices.

15. A tangible, non-transitory, computer-readable medium comprising instructions encoded therein, wherein the instructions when executed by a processor, cause the processor to:
receive an internet protocol (IP) address corresponding to a recipient device;
determine one or more mobile computing devices associated with the IP address, wherein the one or more mobile computing devices are indicated as having previously established an internet connection via the IP address;
process historical data received from the one or more mobile computing devices, wherein the historical data comprises location data identifying geographical coordinates at which the one or more mobile computing devices were located while connected to the internet via the IP address; and
determine an establishment at which the recipient device is located based on the geographical coordinates, wherein the establishment is located physically proximate to the geographical coordinates.

16. The tangible, non-transitory, computer-readable medium of claim 15, wherein the one or more mobile computing devices being indicated as having previously established an internet connection via the IP address comprises the instructions, when executed by the processor, further causing the processor to detect a unique device identifier, for each of the one or more mobile computing devices, in internet communications routed via the IP address.

17. The tangible, non-transitory, computer-readable medium of claim 15, wherein determining an establishment at which the recipient device is located further comprises the instructions, when executed by the processor, further causing the processor to compare the geographical coordinates at which the one or more mobile computing devices were located while connected to the internet via the IP address to map data comprising metadata including at least physical addresses corresponding to one or more establishments, and wherein a particular physical address corresponding to the establishment is located physically proximate to the geographical coordinates.

18. The tangible, non-transitory, computer-readable medium of claim 17, wherein determining an establishment at which the recipient device is located further comprises the instructions, when executed by the processor, further causing the processor to:
in response to comparing the geographical coordinates to the map data, determine the establishment and at least one other establishment are within a predetermined distance from the geographical coordinates;
further process the historical data, wherein the historical data further comprises time data indicative of a time duration during which the one or more mobile computing devices were connected to the internet via the IP address;
process the metadata corresponding to the map data, wherein the metadata corresponding to the map data further comprises hours of operation corresponding to the establishment and the at least one other establishment; and
determine the time duration is outside the hours of operation corresponding to the at least one other establishment.

19. The tangible, non-transitory, computer-readable medium of claim 18, wherein receiving an IP address corresponding to a recipient device further comprises the instructions, when executed by the processor, further causing the processor to receive metadata corresponding to a transmission of digital content, the metadata comprising at least a transmission timestamp, and wherein determining an establishment at which the recipient device is located further comprises the instructions, when executed by the processor, further causing the processor to determine the transmission timestamp is outside the hours of operation corresponding to the at least one other establishment.

20. The tangible, non-transitory, computer-readable medium of claim 19, wherein the IP address corresponding to the recipient device is received from a third-party entity associated with the transmission of the digital content.
